(19) United States
(12) Patent Application Publication
(10) Pub. No.: US 2006/0277258 A1
(43) Pub. Date: Dec. 7, 2006

(54) Managing and organizing electronic mail messages via a cross tabulation summary or a histogram

(76) Inventor: Samuel Mark Goldfarb, Raleigh, NC (US)

Correspondence Address: KELLY K. KORDZIK;WINSTEAD SECHREST & MINICK PC, PO BOX 50784, DALLAS, TX, 75201, US

(21) Appl. No.: 11/145,634

(22) Filed: Jun. 6, 2005

(51) Int. Cl. G06F 15/16

(52) U.S. Cl. 709/206

(57) ABSTRACT

A method, computer program product and system for managing and organizing electronic mail messages. A computer system, referred to as a client, may receive input as to a period of time to organize electronic mail messages. The client may further receive sort criteria which is used to sort incoming electronic mail messages over the designated period of time. The client may then generate either a tabulation summary or a histogram, selected by the user, illustrating the electronic mail messages over the period of time that are sorted according to the received criteria. By displaying relevant information regarding e-mail messages received over a designated period of time in either a tabulation summary or a histogram, the user saves time from digesting and sorting out large volumes of electronic mail messages.

### TECHNICAL FIELD

The present invention relates to the field of electronic messaging systems, and more particularly to managing and organizing electronic mail messages via a cross tabulation summary or a histogram.

### BACKGROUND INFORMATION

Electronic messaging, which includes electronic mail (or “e-mail”) messaging, is now an accepted, and some would say vital, medium for business and personal communications. The rapid growth of electronic messaging is expected to continue. This growth brings an increasingly serious problem of how to manage the volume of messages. According to a 1998 Pitney Bowes survey, 71% of respondents said they felt overwhelmed by the number of messages they receive. This problem is becoming more severe.

Electronic messages, which may include attachments of diverse kinds, are sent and received through the use of messaging software. For example, e-mail messages are sent and received by e-mail software such as Microsoft's Outlook™. Current e-mail software, for example, provides rudimentary features for organizing e-mail messages (both incoming and outgoing) into various folders. The most basic model saves received messages in an “inbox” folder, messages waiting delivery in an “outbox” folder, and sent messages in a “sent messages” folder. Users can create additional user folders to which they can move or copy messages. Refinements to this basic model include providing additional system folders such as drafts and wastebasket folders. In general, the user is responsible for moving e-mail messages between folders and for managing the messages once they have been placed into a folder. This can be an onerous responsibility, especially in cases where the user receives large volumes of e-mail messages as may easily occur, for example, if the user subscribes to one or more high volume mailing lists or leaves the office for a period of time, such as for vacation.

Currently, there is no easy way of digesting large volumes of electronic messages that may appear in the user's “inbox” folder. Typically, the e-mail messages are listed according to the time of receipt with the most recent e-mail message listed on top. If there is a large volume of electronic messages, then the user may have to scroll through multiple pages in order to view all of the received e-mail messages. Further, there is no indication provided to the user as to which e-mail messages are important, e.g., need to be addressed soon, and which e-mail messages do not need to be read, e.g., junk e-mail. Hence, the user has to spend time reviewing each of these electronic messages in order to determine which e-mail messages need to be responded.

Therefore, there is a need in the art to manage and organize electronic mail messages in a manner that saves the user time from digesting and sorting out large volumes of electronic mail messages.

### SUMMARY

The problems outlined above may at least in part be solved in some embodiments by generating a cross tabulation summary or a histogram that graphically displays information, e.g., a number of e-mail messages sent by a particular sender for a particular subject, about e-mail messages received over a designated period of time. By displaying relevant information regarding e-mail messages received over a designated period of time in either a tabulation summary or a histogram, the user saves time from digesting and sorting out large volumes of electronic mail messages.

In one embodiment of the present invention, a method for managing and organizing electronic mail messages comprising the step of receiving input as to a period of time to organize electronic mail messages into either a tabulation summary or a histogram. The method may further comprise receiving electronic mail messages over the period of time. The method may further comprise receiving input as to criteria to sort the electronic mail messages received over the period of time. The method may further comprise sorting the electronic mail messages received over the period of time according to the received criteria. The method may further comprise generating either the tabulation summary or the histogram illustrating the electronic mail messages received over the period of time that are sorted according to the received criteria.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system in accordance with an embodiment of the present invention;

FIG. 2 illustrates an embodiment of the present invention of a client;

FIG. 3 is a flowchart of a method for managing and organizing electronic mail messages in accordance with an embodiment of the present invention;

FIG. 4 is a cross tabulation summary illustrating the sorting of incoming e-mail messages according to subject by sender in accordance with an embodiment of the present invention; and

FIG. 5 is a histogram illustrating the sorting of incoming e-mail messages according to subject by sender in accordance with an embodiment of the present invention.

### DETAILED DESCRIPTION

The present invention comprises a method, computer program product and system for managing and organizing electronic mail messages. In one embodiment of the present invention, a computer system, referred to as a client, may receive input as to a period of time to organize electronic mail messages. The client may further receive sort criteria which is used to sort incoming electronic mail messages over the designated period of time. The client may then generate either a tabulation summary or a histogram, selected by the user, illustrating the electronic mail messages over the period of time that are sorted according to the received criteria. By displaying relevant information regarding e-mail messages received over a designated period of time in either a tabulation summary or a histogram, the user saves time from digesting and sorting out large volumes of electronic mail messages.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

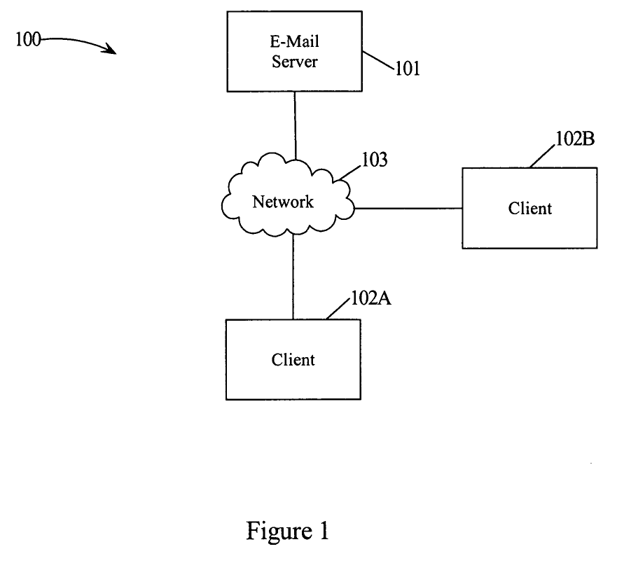

FIG. 1—Network System

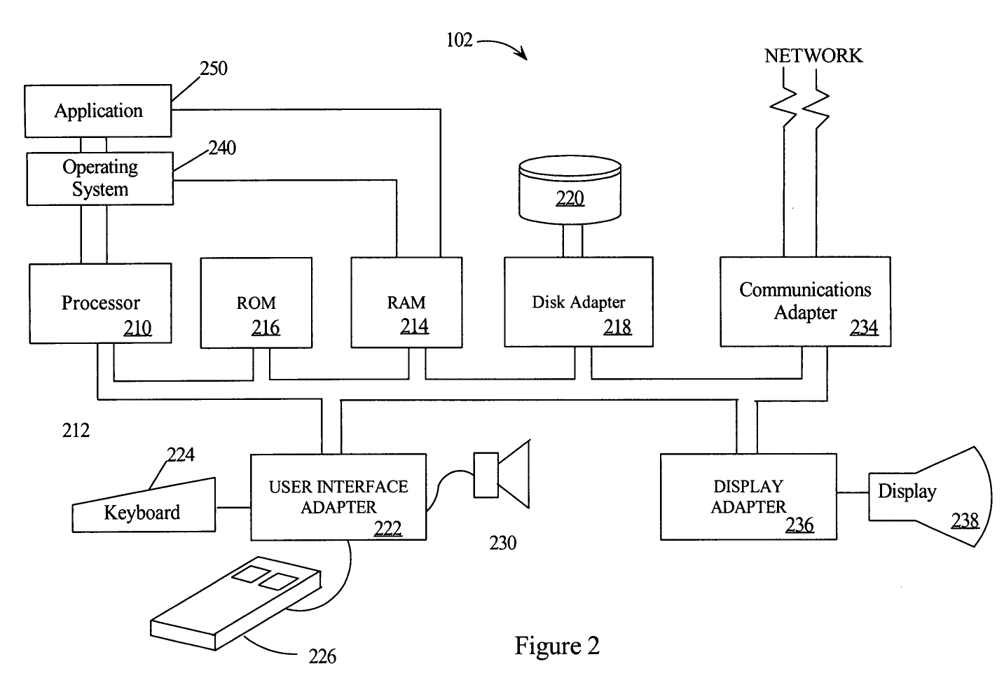

FIG. 1 illustrates an embodiment of the present invention of a network system 100 which connects an electronic mail (e-mail) server 101 with clients 102A-B via a network 103, e.g., local area network (LAN), wide area network (WAN). Clients 102A-B may collectively or individually be referred to as clients 102 or client 102, respectively. A detail description of client 102 is provided below in association with FIG. 2. It is noted that network system 100 may include any number of e-mail servers 101 and clients 102 and that FIG. 1 is illustrative. It is further noted that network system 100 may include other components, e.g., routers, that were not depicted for ease of understanding and that the scope of the present invention is not limited to the devices depicted in FIG. 1.

E-mail server 101 may run e-mail messaging server software configured to route e-mail messages sent from one client 102, e.g., client 102A, to another client 102, e.g., client 102B. Each client 102 may run messaging client software. Clients 102 may exchange electronic mail messages by way of server 101 and network 103. For example, a user of client 102A may use e-mail client software to compose a message addressed to a user of client 102B. When the message is complete, the user indicates to the e-mail client software that the message should be sent, for example by activating a “send” icon. Client 102A then sends the message to server 101 on network 103. Server 101 receives the message, parses the address and forwards the message to client 102B. The message is received at client 102B by e-mail client software which places the message in an “inbox” folder. The user of client 102B can then read the message, respond to the message, delete the message, move the message to another folder, and so on. Over time the user of client 102B may receive a large number of electronic messages from the user of client 102A and others. By way of example, the present invention may be applied to help the user of client 102B to organize, locate and manage such messages.

FIG. 2—Client

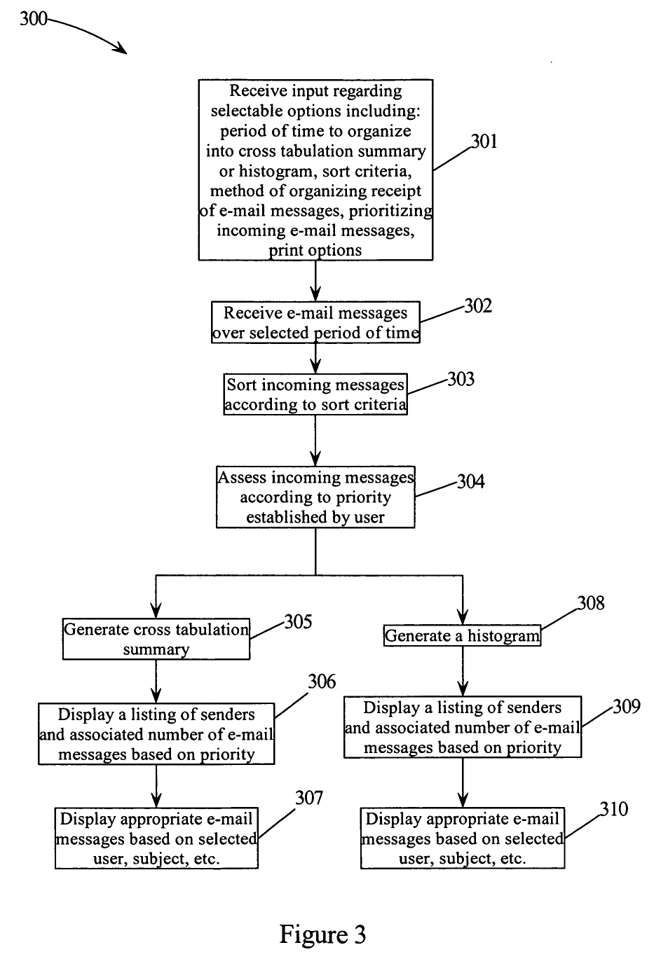

FIG. 2 illustrates a typical hardware configuration of a client 102 (FIG. 1) which is representative of a hardware environment for practicing the present invention. Referring to FIG. 2, client 102 may have a processor 210 coupled to various other components by a system bus 212. An operating system 240, may run on processor 210 and provide control and coordinate the functions of the various components of FIG. 2. An application 250 in accordance with the principles of the present invention may run in conjunction with operating system 240 and provide calls to operating system 240 where the calls implement the various functions or services to be performed by application 250. Application 250 may include, for example, a program for managing and organizing electronic mail messages as discussed below in association with FIG. 3.

Read only memory (ROM) 216 may be coupled to system bus 212 and include a basic input/output system (“BIOS”) that controls certain basic functions of client 102. Random access memory (RAM) 214 and disk adapter 218 may also be coupled to system bus 212. It should be noted that software components including operating system 240 and application 250 may be loaded into RAM 214 which may be client's 102 main memory. Disk adapter 218 may be an integrated drive electronics (“IDE”) adapter that communicates with a disk unit 220, e.g., disk drive. It is noted that the application for managing and organizing electronic mail messages, as discussed below in association with FIG. 3, may reside in disk unit 220 or in application 250.

Referring to FIG. 2, communications adapter 234 may also be coupled to system bus 212. Communications adapter 234 may interconnect bus 212 with an outside network 103 (FIG. 1) enabling client 102, e.g., client 102A, to electronically mail a message to an intended recipient, e.g., client 102B, as identified in the address of the e-mail message.

Input/Output devices may also be connected to system bus 212 via a user interface adapter 222 and a display adapter 236. Keyboard 224, mouse 226 and speaker 230 may all be interconnected to bus 212 through user interface adapter 222. Event data may be inputted to client 102 through any of these devices. A display monitor 238 may be connected to system bus 212 by display adapter 236. In this manner, a user is capable of inputting to client 102 through keyboard 224 or mouse 226 and receiving output from client 102 via display 238 or speaker 230.

Implementations of the present invention include implementations as a computer system (client 102) programmed to execute the method or methods described herein, and as a computer program product. According to the computer system implementations, sets of instructions for executing the method or methods may be resident in the random access memory 214 of one or more computer systems configured generally as described above. Until required by client 102, the set of instructions may be stored as a computer program product in another computer memory, for example, in disk drive 220 (which may include a removable memory such as an optical disk or floppy disk for eventual use in disk drive 220). Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

As stated in the Background Information section, currently, there is no easy way of digesting large volumes of electronic messages that may appear in the user's “inbox” folder. Typically, the e-mail messages are listed according to the time of receipt with the most recent e-mail message listed on top. If there is a large volume of electronic messages, then the user may have to scroll through multiple pages in order to view all of the received e-mail messages. Further, there is no indication provided to the user as to which e-mail messages are important, e.g., need to be addressed soon, and which e-mail messages do not need to be read, e.g., junk e-mail. Hence, the user has to spend time reviewing each of these electronic messages in order to determine which e-mail messages need to be responded. Therefore, there is a need in the art to manage and organize electronic mail messages in a manner that saves the user time from digesting and sorting out large volumes of electronic mail messages. A method for managing and organizing electronic mail messages in a manner that saves the user time from digesting and sorting out large volumes of electronic mail messages is described below in association with FIG. 3.

FIG. 3—Method for Managing and Organizing Electronic Mail Messages

FIG. 3 is a flowchart of one embodiment of the present invention of a method 300 for managing and organizing electronic mail messages.

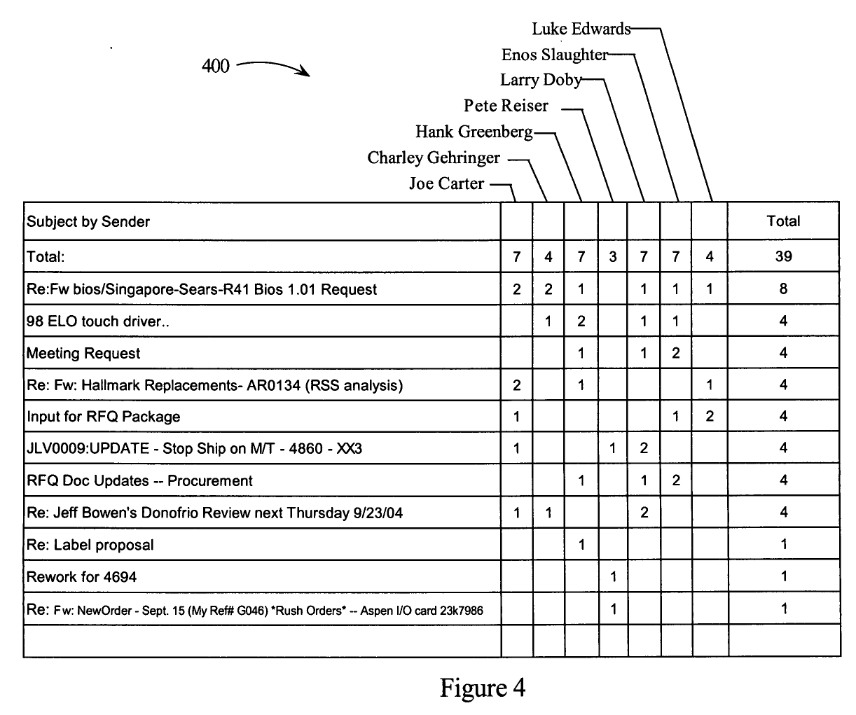

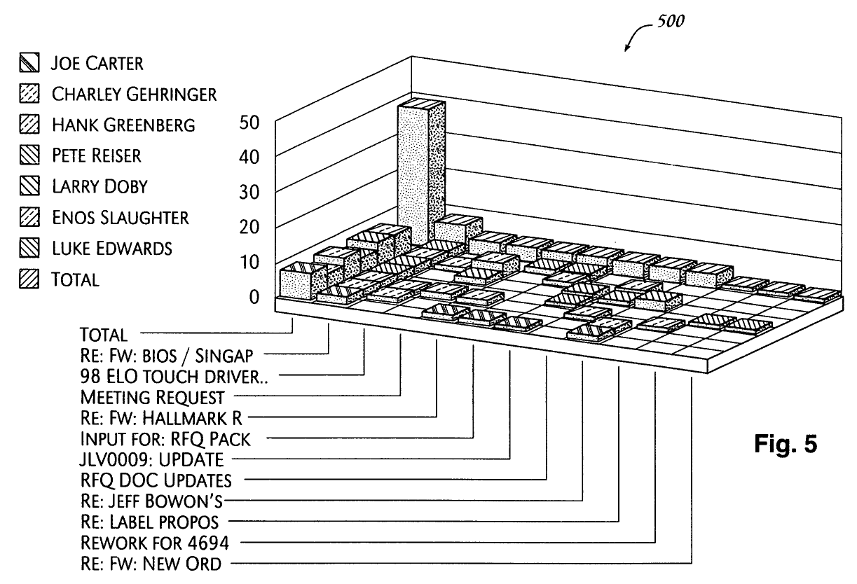

Referring to FIG. 3, in conjunction with FIGS. 1-2, in step 301, client 102 receives various inputs from the user. For example, the user may provide a period of time, e.g., 1 week, to organize e-mail messages received over the designated period of time into a cross tabulation summary (example described below in association with FIG. 4) or a histogram (example described below in association with FIG. 5). In another example, the user may provide criteria in which client 102 sorts the incoming e-mail messages received over the designated period of time, e.g., 1 week. For example, the user may request that the incoming e-mail messages be sorted by subject and sender. It is noted that the incoming e-mail messages may be sorted using different criteria and that such different criteria would fall within the scope of the present invention. In another example, the user may indicate the method (e.g., tabulation summary, histogram) of organizing the e-mail messages received over the designated period of time. In another example, the user may provide client 102 with data as to how to prioritize the incoming e-mail messages over the designated period of time. For example, the user may designate different priority levels (e.g., on a scale from 1 to 5 with 5 being the highest priority) based on the identity of the sender. For instance, e-mails received from either the chief executive officer or from the President may receive a priority level of 5; whereas, e-mails received from an advertiser may receive a priority level of 1. These e-mails may be displayed in the order of priority from highest to lowest in a histogram or in a cross tabulation summary. The priority of the e-mail messages may be color coded to make it easier for the user to identify e-mail messages of various priorities. In this manner, the user will be able to identify e-mails of importance more easily. In another example of input received by a user, the user may input particular print options such as printing to a hardcopy or to a spreadsheet that allows for extra-wide viewing for ease of reading.

In step 302, client 102 receives e-mail messages over the designated period of time (referring to the time period inputted by the user in step 301).

In step 303, client 102 sorts the incoming e-mail messages according to the sort criteria, e.g., subject and sender, inputted by the user in step 301.

In step 304, client 102 assesses the incoming e-mail messages according to the priority established by the user. That is, client 102 assesses the incoming e-mail messages according to the priority levels inputted by the user as discussed above.

In step 305, client 102 generates a cross tabulation summary illustrating the e-mail messages received over the designated period of time that are sorted according to the received criteria, e.g., subject, sender. FIG. 4 illustrates an example of such a cross tabulation summary in accordance with an embodiment of the present invention. Referring to FIG. 4, cross tabulation summary 400 illustrates sorting incoming e-mail messages according to subject by sender. For example, the sender with the name of Joe Carter sent a total of 7 e-mail messages. The subject matter of these 7 e-mail messages along with the number of e-mail messages directed to such subject matter include: Sears (2 of the 7 e-mail messages); Hallmark (2 of the 7 e-mail messages); a RFQ package (1 of the 7 e-mail messages), a “Stop Ship on M/T” (1 of the 7 e-mail messages); and Jeff Bowen's review (1 of the 7 e-mail messages). By having e-mail messages sorted in a cross tabulation summary, it is easier for the user to manage and organize e-mail messages thereby saving the user time from digesting and sorting.

Referring to FIG. 3, in conjunction with FIGS. 1-2 and 4, in step 306, client 102 displays a listing of senders and associated number of e-mail messages based on priority in a cross tabulation summary. For example, referring to FIG. 4, if the user selected e-mail messages from Joe Carter to have the highest priority level and e-mail messages from Luke Edwards to have the lowest priority level, then Joe Carter may appear in the first column of the listing of senders and Luke Edwards may appear in the last column in the listing of senders. Furthermore, the names of these senders may be color coded (not shown) thereby making it easier for the user to identify e-mail messages that are of importance.

In step 307, client 102 displays appropriate e-mail messages (the content of the e-mail messages) based on the user selecting a link in the cross tabulation summary. For example, referring to FIG. 4, the name of each sender may be a link to the content of the e-mail messages sent by that sender. For instance, when the user selects the name of a sender, the content of each of the e-mail messages sent by that sender may be displayed to the user. In another instance, the number that indicates the number of e-mail messages sent by a particular sender for a particular subject may be a link. When the user activates that link, client 102 may display the content of those e-mail messages associated with that number. For example, if the user selected the number “1” under the column labeled “Joe Carter”, then the content of the e-mail message regarding Jeff Bowen's review may appear to the user.

Alternatively to step 305, client 102 generates, in step 308, a histogram illustrating the e-mail messages received over the designated period of time that are sorted according to the received criteria, e.g., subject, sender. FIG. 5 illustrates an example of such a histogram in accordance with an embodiment of the present invention. Referring to FIG. 5, histogram 500 illustrates sorting incoming e-mail messages according to subject by sender. For example, the total number of e-mail messages sent by each sender for each subject matter may be represented by a graphical bar, the height of which corresponds to the number of such e-mail messages. Further, each graphical bar may be associated with a color used to identify a particular sender. By having e-mail messages sorted in a histogram, it is easier for the user to manage and organize e-mail messages thereby saving the user time from digesting and sorting.

Referring to FIG. 3, in conjunction with FIGS. 1-2 and 5, in step 309, client 102 displays a listing of senders and associated number of e-mail messages based on priority in a histogram. For example, referring to FIG. 5, if the user selected e-mail messages from Joe Carter to have the highest priority level and e-mail messages from Luke Edwards to have the lowest priority level, then the number of e-mail messages sent by Joe Carter may appear in the first row and the number of e-mail messages sent by Luke Edwards may appear in the last row. Furthermore, the names of these senders as well as the associated bar graphs may be color coded (not shown) thereby making it easier for the user to identify e-mail messages that are of importance.

In step 310, client 102 displays appropriate e-mail messages (the content of the e-mail messages) based on the user selecting a link in the histogram. For example, referring to FIG. 5, the name of each sender may be a link to the content of the e-mail messages sent by that sender. For instance, when the user selects the name of a sender, the content of each of the e-mail messages sent by that sender may be displayed to the user. In another instance, the bar graph that indicates the number of e-mail messages sent by a particular sender for a particular subject may be a link. When the user activates that link, client 102 may display the content of those e-mail messages associated with that bar graph.

It is noted that method 300 may include other and/or additional steps that, for clarity, are not depicted. It is further noted that method 300 may be executed in a different order presented and that the order presented in the discussion of FIG. 3 is illustrative. It is further noted that certain steps in method 300 may be executed in a substantially simultaneous manner.

Although the method, computer program product and system are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for managing and organizing electronic mail messages comprising the steps of:
receiving input as to a period of time to organize electronic mail messages into one of a tabulation summary and a histogram;
receiving electronic mail messages over said period of time;
receiving input as to criteria to sort said electronic mail messages received over said period of time;
sorting said electronic mail messages received over said period of time according to said received criteria; and
generating one of said tabulation summary and said histogram illustrating said electronic mail messages received over said period of time that are sorted according to said received criteria.

2. The method as recited in claim 1 further comprising the steps of:
receiving input prioritizing said electronic mail messages received over said period of time; and
assessing said electronic mail messages received over said period of time based on said received input prioritizing said electronic mail messages received over said period of time.

3. The method as recited in claim 2 further comprising the step of:
displaying said electronic mail messages received over said period of time in one of said tabulation summary and said histogram in a particular order based on said received input prioritizing said electronic mail messages received over said period of time.

4. The method as recited in claim 1, wherein said sort criteria comprises criteria to sort electronic mail messages received over said period of time by subject matter and sender.

5. The method as recited in claim 4 further comprising the step of:
displaying an indication of a number of e-mail messages sent by a particular sender for a particular subject matter for each of a plurality of senders who sent electronic mail messages over said period of time.

6. The method as recited in claim 5 further comprising the step of:
displaying one or more e-mail messages associated with a first of said plurality of senders upon selection of an indication of said first sender.

7. The method as recited in claim 5 further comprising the step of:
displaying one or more messages associated with a first subject matter upon selection of an indication of said first subject matter.

8. A computer program product embodied in a machine readable medium for managing and organizing electronic mail messages comprising the programming steps of:
receiving input as to a period of time to organize electronic mail messages into one of a tabulation summary and a histogram;
receiving electronic mail messages over said period of time;
receiving input as to criteria to sort said electronic mail messages received over said period of time;
sorting said electronic mail messages received over said period of time according to said received criteria; and
generating one of said tabulation summary and said histogram illustrating said electronic mail messages received over said period of time that are sorted according to said received criteria.

9. The computer program product as recited in claim 8 further comprising the programming steps of:
receiving input prioritizing said electronic mail messages received over said period of time; and
assessing said electronic mail messages received over said period of time based on said received input prioritizing said electronic mail messages received over said period of time.

10. The computer program product as recited in claim 9 further comprising the programming step of:
displaying said electronic mail messages received over said period of time in one of said tabulation summary and said histogram in a particular order based on said received input prioritizing said electronic mail messages received over said period of time.

11. The computer program product as recited in claim 8, wherein said sort criteria comprises criteria to sort electronic mail messages received over said period of time by subject matter and sender.

12. The computer program product as recited in claim 11 further comprising the programming step of:
displaying an indication of a number of e-mail messages sent by a particular sender for a particular subject matter for each of a plurality of senders who sent electronic mail messages over said period of time.

13. The computer program product as recited in claim 12 further comprising the programming step of:
displaying one or more e-mail messages associated with a first of said plurality of senders upon selection of an indication of said first sender.

14. A system, comprising:
a memory unit operable for storing a computer program operable for managing and organizing electronic mail messages; and
a processor coupled to said memory unit, wherein said processor, responsive to said computer program, comprises:
circuitry for receiving input as to a period of time to organize electronic mail messages into one of a tabulation summary and a histogram;
circuitry for receiving electronic mail messages over said period of time;
circuitry for receiving input as to criteria to sort said electronic mail messages received over said period of time;
circuitry for sorting said electronic mail messages received over said period of time according to said received criteria; and
circuitry for generating one of said tabulation summary and said histogram illustrating said electronic mail messages received over said period of time that are sorted according to said received criteria.

15. The system as recited in claim 14, wherein said processor further comprises:
circuitry for receiving input prioritizing said electronic mail messages received over said period of time; and
circuitry for assessing said electronic mail messages received over said period of time based on said received input prioritizing said electronic mail messages received over said period of time.

16. The system as recited in claim 15, wherein said processor further comprises:
circuitry for displaying said electronic mail messages received over said period of time in one of said tabulation summary and said histogram in a particular order based on said received input prioritizing said electronic mail messages received over said period of time.

17. The system as recited in claim 14, wherein said sort criteria comprises criteria to sort electronic mail messages received over said period of time by subject matter and sender.

18. The system as recited in claim 17, wherein said processor further comprises:
circuitry for displaying an indication of a number of e-mail messages sent by a particular sender for a particular subject matter for each of a plurality of senders who sent electronic mail messages over said period of time.

19. The system as recited in claim 18, wherein said processor further comprises:
displaying one or more e-mail messages associated with a first of said plurality of senders upon selection of an indication of said first sender.

20. The system as recited in claim 18, wherein said processor further comprises:
displaying one or more messages associated with a first subject matter upon selection of an indication of said first subject matter.
